(19) United States
(12) Patent Application Publication
(10) Pub. No.: US 2015/0242910 A1
(43) Pub. Date: Aug. 27, 2015

(54) METHODS FOR EVALUATING A NETWORK ASSOCIATED WITH AN ORGANIZATION AND DEVICES THEREOF

(71) Applicant: Wipro Limited, Bangalore (IN)

(72) Inventors: Guhu Ramasubramanian, Bangalore (IN); Siddharth Mahesh, Chennai (IN)

(73) Assignee: Wipro Limited, Bangalore (IN)

(21) Appl. No.: 14/191,863

(22) Filed: Feb. 27, 2014

(51) Int. Cl. G06Q 30/02

(52) U.S. Cl. CPC G06Q 30/0283

(57) ABSTRACT

A method, non-transitory computer readable medium and network analyzer device that generates a relationship health score for a plurality of entities based on relationship utility scores and relationship strength scores generated for each pair of one of a plurality of connects and one of a plurality of connectors having a relationship. Next, connect dependence scores are generated for each of the connects. A total monetary value of the network is then generated based on a potential monetary value of the network and a realized monetary value of the network. The potential and realized monetary values are respectively generated based on potential and executed interactions between the connectors and the connects. A total value of the network is then generated based on the relationship health scores, the connect dependence scores, and the total monetary value of the network. The total value of the network is output to an information consumer device.

This application claims the benefit of Indian Provisional Patent Application Filing Number 900/CHE/2013, filed on Mar. 1, 2013, which is hereby incorporated by reference in its entirety.

### FIELD

This technology relates to network analysis, and particularly to methods for analyzing the value of a network associated with an organization and devices thereof.

### BACKGROUND

Personal relationships of members of an organization with external contacts, such as customers, are often the foundation of successful operation of the organization. Many organizations depend significantly on, and derive value from, the individual relationships and interactions that members of the organization have with external contacts and entities. However, understanding and analyzing an organization's network can be difficult, particularly with respect to large organizations. In many organizations, teams are organized based on function, division, and/or geography, for example, with limited interaction across teams or awareness of the network of connections associated with other teams.

Although social networks are widely used by individuals, analyzing social networks has significant drawbacks when used to analyze the value of networks of enterprises or organizations. For example, social networks require bilateral acceptance of connections, which may not be possible for casual meetings or business contacts. Adoption of social networks is also limited both within an organization and external to an organization. Additionally, social network connections are often private and an organization may not be able to mandate sharing of the connections. Finally, analyzing the strength of connections using social networks, which can be useful in analyzing the value of a network, is generally not possible or effective.

Current market relationship management and customer relationship management systems are also ineffective for determining the value of an organization's network. For example, contacts in such systems are generally derivative of interactions at an account level and reflective of relationships between an organization and external entities, and not individuals with the organizations or external entities. Additionally, the ability to share information in these systems can be limited and access controls often limit the extent of detail available for analyzing organizational network value.

### SUMMARY

A method for evaluating a network associated with an organization includes generating, with the network analyzer device, a relationship health score for each of a plurality of entities. The relationship health score is generated based on relationship utility scores and relationship strength scores generated for each pair of one of a plurality of connects and one of a plurality of connectors having a relationship. The connectors are internal to the organization and the connects are each associated with one or more of the entities external to the organization. Next, one or more connect dependence scores are generated, with the network analyzer device, for each of the connects. In this exemplary method, a total monetary value of the network is then generated with the network analyzer device. The total monetary value is generated based on a potential monetary value of the network and a realized monetary value of the network. The potential and realized monetary values are respectively generated based on potential and executed interactions between the connectors and the connects. A total value of the network is generated with the network analyzer device based on the relationship health scores, the connect dependence scores, and the total monetary value of the network. The total value of the network is output with the network analyzer device to an information consumer device.

A non-transitory computer readable medium having stored thereon instructions for evaluating a network associated with an organization comprising machine executable code which when executed by a processor, causes the processor to perform steps including generating a relationship health score for each of a plurality of entities. The relationship health score is generated based on relationship utility scores and relationship strength scores generated for each pair of one of a plurality of connects and one of a plurality of connectors having a relationship. The connectors are internal to the organization and the connects are each associated with one or more of the entities external to the organization. Next, one or more connect dependence scores are generated for each of the connects. Additional steps in this example include generating a total monetary value of the network. The total monetary value is generated based on a potential monetary value of the network and a realized monetary value of the network. The potential and realized monetary values are respectively generated based on potential and executed interactions between the connectors and the connects. A total value of the network is then generated based on the relationship health scores, the connect dependence scores, and the total monetary value of the network. The total value of the network is output to an information consumer device.

A network analyzer device includes a processor coupled to a memory and configured to execute programmed instructions stored in the memory including generating a relationship health score for each of a plurality of entities. The relationship health score is generated based on relationship utility scores and relationship strength scores generated for each pair of one of a plurality of connects and one of a plurality of connectors having a relationship. The connectors are internal to the organization and the connects are each associated with one or more of the entities external to the organization. Next, one or more connect dependence scores are generated for each of the connects. The programmed instructions in this example further include generating a total monetary value of the network. The total monetary value is generated based on a potential monetary value of the network and a realized monetary value of the network. The potential and realized monetary values are respectively generated based on potential and executed interactions between the connectors and the connects. A total value of the network is then generated based on the relationship health scores, the connect dependence scores, and the total monetary value of the network. The total value of the network is output to an information consumer device.

This technology provides a number of advantages including providing more effective methods, non-transitory computer readable medium and devices for analyzing the value of a network associated with an organization. With this technology, strength and utility of relationships among connectors of an organization and connects associated with entities external to the organization, as well as dependence of the organization on particular connections, are quantified. A total value for the network is then advantageously determined based on the health of relationships of the organization with external entities, the dependence on each connection, and the potential and realized monetary value of the network. Thereby, the value of an organization's network is advantageously quantified and can be used to determine change in the network's value over time, as well as to compare the value of portions of the network, for example.

### BRIEF DESCRIPTION OF THE DRAWINGS

FIG. 1 a block diagram of a network environment with an exemplary network analyzer device;

FIG. 2 is a flowchart of an exemplary method for evaluating a network associated with an organization; and

FIG. 3 is a table with exemplary attributes captured by the exemplary network analyzer device for various connects associated with an organization's network.

### DETAILED DESCRIPTION

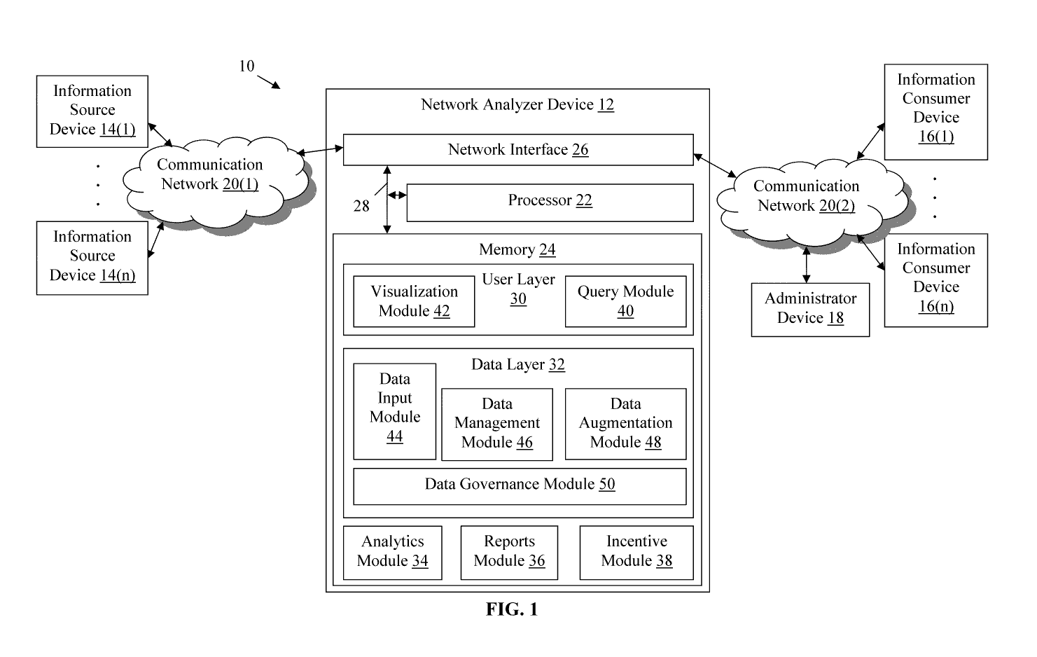

An environment 10 with an exemplary network analyzer device 12 coupled to information source devices 14(1)-14(n), information consumer devices 16(1)-16(n), and an administrator device 18 by communication network 20(1) and 20(2) is illustrated in FIG. 1. Other numbers and types of systems, devices, and/or elements in other configurations and environments with other communication network topologies can also be used. This technology provides a number of advantages including methods, non-transitory computer readable medium, and devices that facilitate more effective analysis of the value of a network associated with an organization.

The network analyzer device 12 in this example includes a processor 22, a memory 24, and a network interface 26 coupled together by a bus 28 or other link, although the network analyzer device 12 can include other numbers and types of components, parts, devices, systems, and elements in other configurations. The processor 22 in the network analyzer device 12 can execute a program of instructions for one or more aspects of the present invention as described and illustrated herein, although the processor 22 could also execute other numbers and types of programmed instructions.

The memory 24 in the network analyzer device 12 stores these programmed instructions for one or more aspects of the present invention as described and illustrated herein, although some or all of the programmed instructions could be stored and/or executed elsewhere. A variety of different types of memory storage devices, such as random access memory (RAM), read only memory (ROM), one or more hard disk or solid state drives, or other computer readable medium which is read from and/or written to by a magnetic, optical, or other reading and/or writing system that is coupled to the processor 22, can be used for the memory 24 in the network analyzer device 12.

The memory 24 in this example includes a user layer 30, a data layer 32, an analytics module 34, a reports module 36, and an incentive module 38. The user layer 30 is an interface between an end user, such as a user of one of the information consumer devices 16(1)-16(n) for example, and the network analyzer device 12 and includes a query module 40 and a visualization module 42, although other modules can also be provided.

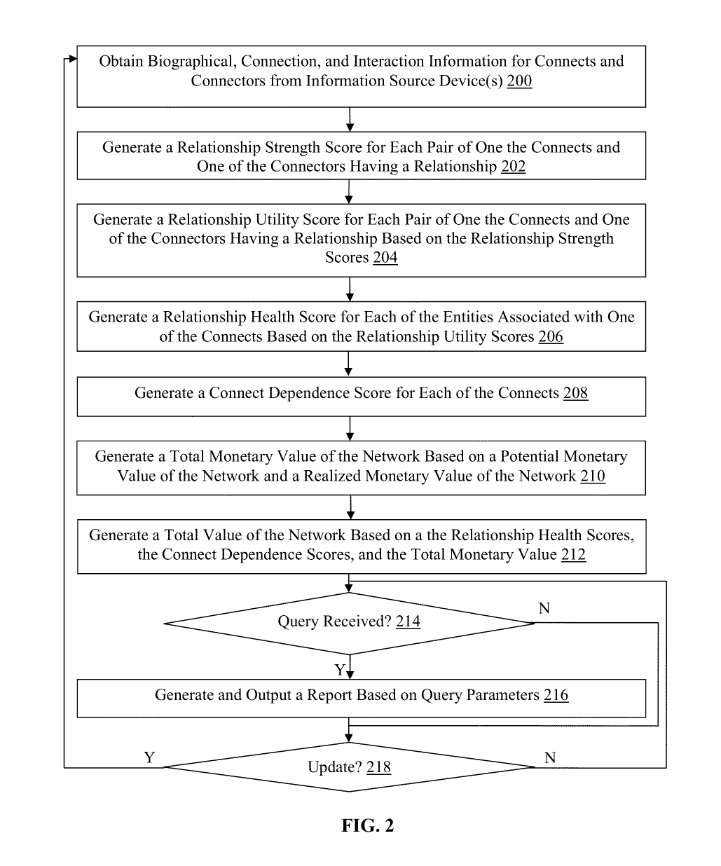

In this example, the query module 40 receives requests from the information consumer devices 16(1)-16(n) for information regarding an organization's network including the strength of any connection, relationship health with respect to a particular entity or group of entity, relationship utility, connection dependence, and potential, realized, or total value associated with any actor in the network, for example, as determined as described and illustrated in more detail later with reference to FIG. 2. Other types of queries for other information can also be processed by the query module 40. The visualization module can display various network factors graphically, including changes in the factors over time, to enable analysis by users of the information consumer device 16(1)-16(n).

The data layer 32 of the network analyzer device 12 in this example includes a data input module 44, a data management module 46, a data augmentation module 48, and a data governance module 50, although other modules can also be provided. The data input module 44 of the data layer 32 in this example processes structured or unstructured data associated with various actors associated with an organization's network obtained from the information source devices 14(1)-14(n), for example.

The data management module 46 of the data layer 32 in this example processes the data obtained by the data input module 44 to structure the data into the memory 24, such as in one or more databases, based on stored rules. The data governance module 50 of the data layer 32 in this example ensures data standards are maintained through data enrichment and augmentation. The data augmentation module 48 of the data layer 32 in this example ensures that changes and updates to data associated with actors in an organization's network, as retrieved from the information source devices 14(1)-14(n), are reflected in the data regarding the network stored in the memory 24.

The analytics module 34 of the network analyzer device 12 generates predictive and descriptive analytics regarding an organization's network based on the data obtained by the data input module 44, for example. The reports module of the network analyzer device 12 generates a display or output of the information corresponding to queries received by the query module 40 of the user layer 30, for example, to be provided to a requesting one of the information consumer devices 16(1)-16(n) in a manner that is shareable through various mediums across an organization.

In this example, the incentive module 38 of the network analyzer device 12 can monitor interactions among actors in an organization's network and generate and provide rewards for influencing or assisting in deals, recruitments, or acquisitions, for example, which leverage an organization's network. The rewards can be proportional to the contribution of an actor and/or the value of the interaction, for example, although other types and manners of generating rewards can also be used.

Each of the information source devices 14(1)-14(n) in this example includes a processor, a memory, and a communication interface, which are coupled together by a bus or other link, although other numbers and types of network devices with other elements could be used. The information source devices 14(1)-14(n) in this example can be various sources of information regarding actors in an organization's network. Accordingly, the information source devices 14(1)-14(n) can include internal systems of an organization, social network data servers, sales customer relationship management (CRM) systems, or any other back office type of system storing information regarding actors associated with an organization's network, such as relationships and interactions, for example, as described and illustrated in more detail later.

Each of the information consumer devices 16(1)-16(n) in this example includes a processor, a memory, and a communication interface, which are coupled together by a bus or other link, although other numbers and types of network devices with other elements could be used. The information consumer devices 16(1)-16(n) can further include an input device and a display device and may be configured to run interface applications, such as Web browsers, that may provide an interface to send queries to the query module 40 of the network analyzer device 12 and/or receive output from the visualization module 42 and/or the reports module 36 of the network analyzer device 12.

The administrator device 18 in this example includes a processor, a memory, and a communication interface, which are coupled together by a bus or other link, although other numbers and types of network devices with other elements could be used. The administrator device 18 can further include an input device and a display device and may be configured to run interface applications, such as Web browsers, that may provide an interface to configure, manage, control, or otherwise program the network analyzer device 12, for example.

The communication networks 20(1) and 20(2) in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like. The communication networks 20(1) and 20(2) may comprise any local area network (LAN) or wide area network (e.g., Internet), although any other type of traffic network topology may be used.

Although an exemplary network environment 10 with the network analyzer device 12, information source devices 14(1)-14(n), information consumer devices 16(1)-16(n), administrator device 18, and communication networks 20(1) and 20(n) is described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

An exemplary method for evaluating a network associated with an organization will now be described with reference to FIGS. 1-3. Referring more specifically to FIG. 2, in step 200 the network analyzer device 12 obtains information for connects and connectors associated with an organization. As used herein, a “connect” refers to an individual within an organization or internal to the organization's network, a “connector” refers to an individual outside the organization or external to the organization's network, and connects and connectors are collectively referred to as “actors” in the organization's network. For example, a connect may be an employee of the organization and a connector may be an employee of an entity that is a customer of the organization, although there are many other exemplary types of connects and connectors.

In this example, biographical, connection, and interaction information is obtained in step 200 by the network analyzer device 12 for each of the connects and connectors associated with an organization, although other types of information can also be obtained in step 200. The information can be obtained by the network analyzer device 12 from the information source devices 14(1)-14(n), for example, although some or all of the information can be obtained elsewhere. Optionally, the data input module 44 of the network analyzer device 12 facilitates the obtaining of the information from the information source devices 14(1)-14(n) in step 200, as described and illustrated earlier.

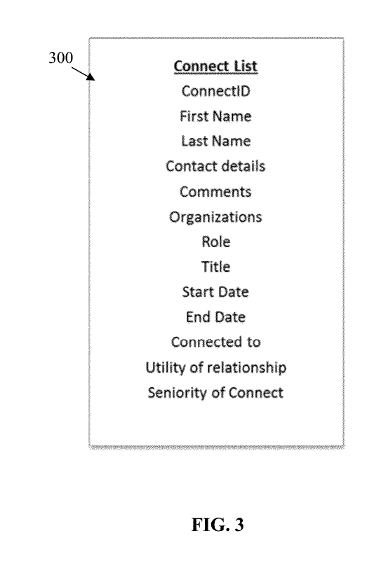

Referring to FIG. 3, a table 300 with exemplary information captured by the network analyzer device 12 for various connects associated with an organization's network is illustrated. In this example, the network analyzer device 12 obtains or establishes a unique identifier for each connect. The unique identifier can then be associated with obtained biographical information, such as name, associated organization, role, title, and/or seniority, as well as obtained relationship information including an indication of who the connect is connected to (e.g., which connectors). Corresponding information can also be obtained for connectors, although different information can also be obtained for the connectors.

Referring back to FIG. 2, in this example, interaction information for interactions, such as communications, meetings, and/or proposed or completed sales, for example, can also be obtained in step 200. Accordingly, the network analyzer device 12 and/or one or more of the information source devices 14(1)-14(n) can be configured to monitor and store information regarding interactions between connects and connectors. In particular, the time and/or date of the interactions, whether an interaction was positive or negative, and/or the cost associated with the interaction when the interaction is a proposed sale can be maintained by one or more of the information source devices 14(1)-14(n) and obtained by the network analyzer device 12, although other information can also be obtained in step 200.

In step 202, the network analyzer device 12 generates a relationship strength score for each pair of one of the connects and one of the connectors having a relationship. Whether a connect and a connector have a relationship can be determined by the network analyzer device 12 based on the information obtained in step 200, for example. In one example, the relationship strength score (Rᵢⱼ) for the i^{th} and j^{th} actors in the organization's network can be determined as follows:

$${R}_{ij} = {\sum }_{i = 1}^{n} ( {NOR}_{ij} * {b}_{ij} * {C}_{ij} ) \cdot {e}^{- t} ,$$

where NoRᵢⱼ is a nature of relationship score, bᵢⱼ is a value indicating the bilaterality of the relationship, C is a value indicative of the context of the relationship, n is a number of interactions, and t is a value indicating the recency of the interaction.

In this example, NoRᵢⱼ is a value established based on a scale (e.g., 1-10) and indicates the nature of the relationship ranging from business to personal. The nature of the relationship can be determined by the network analyzer device 12 based on the context of the information obtained in step 200 for various interactions between the actors. For example, if actor i and actor j have an interaction based on a social media connection, then the network analyzer device 12 may assign the nature of relationship score to indicate that the relationship is likely personal. In another example, if actor i and j have an interaction based on a sale of a product or service provided by the organization, as recorded by one of the information source devices 14(1)-14(n) that includes a customer relationship management system, for example, then the network analyzer device 12 may assign the nature of relationship score to indicate that the relationship is likely business. Other information and combinations of information obtained in step 200 and other methods can be used to assign the nature of the relationship score.

In this example, bᵢⱼ can be a 0 or a 1 depending on whether the interaction is unilateral or bilateral, respectively, for example, as determined based on the information obtained for the actors in step 200, although other methods of establishing the bilaterality of the relationship can also be used. The relationship context can be a value between −1 and 1 depending on whether the interaction is negative or positive, respectively, for example. In one example, the network analyzer device 12 can determine that the interaction between actors i and j is a completed sale, which may be indicative of a positive interaction. Other values and methods of establishing a relationship context can also be used and other methods of determining the relationship strength score for the i^{th} and j^{th} actor in the organization's network can also be used.

In step 204, the network analyzer device 12 generates a relationship utility score for each pair of one of the connects and one of the connectors having a relationship. The relationship utility scores are indicative of how useful a particular relationship could be for the organization's network. In this example, the relationship utility scores are generated based on the relationship strength scores generated in step 202. Accordingly, in one example, the relationship utility score (UoRᵢⱼ) for the i^{th} and j^{th} actor in the organization's network can be determined as follows:

UoRᵢⱼ=Rᵢⱼ*hᵢⱼ*f(u)*ψ,

where Rᵢⱼ is the relationship strength score generated in step 202, hᵢⱼ is a hierarchical score, f(u) is a value indicative of the effectiveness of the actors, and ψ is a value indicative of the propensity of the actors to influence an interaction.

In this example, hᵢⱼ is determined based on the seniority of the actors with respect to their respective organizations. The seniority of the actors can be obtained by the network analyzer device 12 from one of the information source devices 14(1)-14(n) in step 200. f(u) can be determined for each actor based on the ratio of the number of positive interactions to the total number of interactions associated with the actor. Optionally, the f(u) can be normalized based on a 1-0 scale, for example, although any other scale or values can be used. The interactions between actors, as well as associated positivity or negativity of the interactions, can be maintained by and obtained from one or more of the information source devices 14(1)-14(n), as described and illustrated earlier.

In this example, ψ can be determined for each actor based on the ratio of the number of accepted requests made by one of the actors to the other actor to the total number of requests made to the one of the actors. The requests can be can be associated with the interactions monitored by the information source device(s) 14(1)-14(n) and/or the network analyzer device 12 can be requests to purchase a product, request to complete a task, or any other request made to an actor on behalf of another actor. Other values and methods of determining hᵢⱼ, f(u) and/or ψ, as well as generating the relationship utility scores can also be used. Additionally, various factors or weights can be applied to one or more of the components of the relationship utility scores.

In step 206, the network analyzer device 12 generates a relationship health score for each of the entities associated with one or more of the connects based on the relationship utility scores generated in step 204. In one example, the entities are customers of the organization and the connects are employees of the customers. In this example, the relationship health score for a customer indicates the health of the relationship between the organization and the customer. Other types of entities and connects can also be used. The relationship health score (CRHᵢ) for each i^{th} entity associated with the organization can be determined as follows:

$$C R {H}_{i} = {\sum }_{j = 1}^{α} {UoR}_{ij} ,$$

where UoRᵢⱼ is the relationship utility score for actors i and j as generated in step 204 and a is the number of connections existing between connects and entities. Accordingly, the customer relationship health score for an entity is the aggregation of the relationship utility scores generated in step 204 for all connects associated with the entity.

In step 208, the network analyzer device 12 generates connect dependence score(s) for each of the connects associated with the organization's network. The connect dependence score is a value indicating the organization's level of dependence on the particular connect with respect to the entity associated with the connect. In one example, the connect dependence score(s) for each connect are generated based on, for each of the entities associated with the organization's network, whether the connect is associated with the entity and a total number of relationships between connectors and connects associated with the entity. In this example, the connect dependence score (CDᵢⱼ) for the for the i^{th} connect with the j^{th} entity can be determined as follows:

$${CD}_{ij} = \frac{k}{Total number of connects for entity j} ,$$

where k is 1 if a relationship between the i^{th} connect and the j^{th} entity exists and k is 0 if a relationship between the i^{th} connect and the j^{th} entity does not exist.

In another example, the connect dependence score(s) for each connect are generated based on, for each of the entities associated with the connect, a seniority score of the connect as compared to a sum of a plurality of seniority scores of all of the connects associated with the entity. The seniority scores can be generated based on the seniority of the actors obtained by the network analyzer device 12 from one of the information source devices 14(1)-14(n) in step 200. Accordingly, in this example, the connect dependence score(s) (CDᵢⱼ) for the i^{th} connect and the j^{th} entity can be determined as follows:

$${CD}_{ij} = \frac{Seniority score {Se}_{i} of the connect i linked to entity j}{Sum of all Seniority Scores of all connects linked to entity j} ,$$

where Seᵢ is a seniority score for the i^{th} connect.

In another example, the connect dependence score(s) for each connect are generated based on a number of relationships between the connect and all of the entities associated with the organization's network as compared to the total number of relationships of all of the connects to all of the entities. In this example, the connect dependence score(s) (CD) for the i^{th} connect can be determined as follows:

$${CD}_{i} = \frac{Number of links from connect i to all entities}{Total number of linkages to all entities} .$$

In yet another example, the connect dependence score(s) for each connect are generated based on a seniority score of the connect as compared to a sum of seniority scores of all of the connects associated with the organization's network, the seniority scores generated based on information obtained by the network analyzer device 12 in step 200, as described and illustrated earlier. Accordingly, in this example, the connect dependence score(s) (CD) for the i^{th} connect can be determined as follows:

$${CD}_{i} = \frac{Seniority score {Se}_{i} of the connect i}{Sum of all Seniority Scores of all connects} ,$$

where Seᵢ is a seniority score for the i^{th} connect. Other methods of determining connect dependence score(s) for connects associated with the organization's network can also be used. Additionally, certain entities can be weighted more or less than other entities based on any number of factors such as size, business relevance, and historical relationship, for example.

In step 210, the network analyzer device generates a total monetary value of the organization's network based on a potential monetary value of the network and a realized monetary value of the network. As described and illustrated earlier, the network analyzer device 12 and/or one or more of the information source devices 14(1)-14(n) can be configured to monitor and store information regarding interactions among connectors and connects, including any value associated with the interaction, whether potential or realized. For example, an interaction between a connector of an organization and a connect of an entity involving an offer to sell the organization's product to the entity associated with the connect may have a potential monetary value associated with the product. Similarly, an interaction involving an actual sale of the product may have a value associated with the product.

Accordingly, in this example, the potential monetary value of the organization's network can be determined as follows:

$$Potential Monetary Value = {\sum }_{i = 1}^{β} ( Dollar value of potential interaction ) ,$$

where β is the number of connections existing between connectors and connects. Accordingly, the network analyzer device 12 can analyze the information obtained in step 200 to determine an aggregate potential monetary value of all interactions of each connector with a connect. Similarly, the realized monetary value of the organization's network can be determined as follows:

$$Realized Monetary Value = {\sum }_{i = 1}^{β} ( Dollar value of executed interaction ) ,$$

where β is the number of connections existing between connectors and connects. Accordingly, the network analyzer device 12 can analyze the information obtained in step 200 to determine an aggregate realized monetary value of all interactions of each connector with a connect. Other methods of determining the potential and/or realized monetary value of the organization's network can also be used.

In this example, the network analyzer device 12 can generate the total monetary value in step 210 based on a sum of the potential and aggregate monetary values for the network. Accordingly, the total monetary value is indicative of the total monetary utility of the network to the organization.

In step 212, the network analyzer device 12 generates a total value of the network based on the relationship health scores generated in step 206, the connect dependence scores generated in step 208, and the total monetary value of the network generated in step 210. Accordingly, in this example, the total value of the network can be determined as follows:

Total Value of network=(Customer Relationship Health*Connect Dependence)+Total Monetary Value,

where the customer relationship health is an aggregation of the relationship health scores generated in step 206 for each of the entities associated with one of the connects associated with the organization's network and the connect dependence is an aggregation of the connect dependency scores generated in step 208 for each of the connects. Accordingly, the total value of the network is indicative of the total utility of the network to the organization. Other methods of generating the total value of the network can also be used.

In step 214, the network analyzer device 12 determines whether a query has been received for any of the information obtained in step 200 and/or scores and/or values generated as described and illustrated earlier with reference to steps 202-212. The query can be received from one of the information consumer device 16(1)-16(n) for example, via an interface provided by the query module 40 of the network analyzer device 12 over the communication network 20(2), although other query sources and methods of receiving a query can also be used. If the network analyzer device 12 determines that a query has been received, then the Yes branch is taken to step 216.

In step 216, the network analyzer device 12 generates and outputs a report based on parameters of the received query. In some examples, queries can be for a total monetary value or total value of the network based on parameters including geography, industry, and/or business function, for example, although any other parameter can also be used. In response, the visualization module 42 and/or reports module 36 of the network analyzer device 12 can operate on and/or filter some or all of the values generated in steps 202-212 in order to generate a response to the query. The generated response can then be provided by the network analyzer device 12 to a requesting one of the information consumer devices 16(1)-16(n) via communication network 20(2). Accordingly, one or more of the scores and/or values generated in steps 2002-212, as well as some or all of the information obtained in step 200, can be stored in the memory 24 of the network analyzer device 12 to be used in step 216 to respond to received queries.

Subsequent to generating and outputting the report in step 216, or if the network analyzer device 12 determines in step 214 that a query has not been received and the No branch is taken, the network analyzer device proceeds to step 218. In step 218, the network analyzer device determines whether there has been any update in the information obtained in step 200 from the information source devices 14(1)-14(n). Optionally, updates to the obtained information can be managed by the data augmentation module 46 of the network analyzer device 12, as described and illustrated earlier.

In one example, the network analyzer device 12 can be configured to periodically communicate via communication network 20(1) with one or more of the information source devices 14(1)-14(n) in order to determine whether the information stored therein has been updated subsequent to performance of step 200 by the network analyzer device. In another example, one or more of the information source devices 14(1)-14(n) can be configured to communicate an update, and optionally the updated information, to the network analyzer device 12 via the communication network 20(1). Other methods of determining whether there has been an update of the information obtained in step 200 can also be used.

If the network analyzer device 12 determines there has not been an update to the information obtained in step 200, then the Yes branch is taken to step 200 and steps 200-212 are repeated using the updated information. In other examples, steps 200-212 are performed periodically. If the network analyzer device 12 determines there has not been an update to the obtained information, then the No branch is taken back to step 214 and the network analyzer device effectively continued to determine whether a query is receive or updated information is available until one of the conditions in steps 214 or 218 is satisfied.

With this technology, human networks associated with organizations can be more effectively analyzed with respect to the value of the networks to the organizations. Connections and relationships of employees associated with the organization and employees of entities or customers of the organization, for example, are analyzed and quantified at an individual level with respect to strength, utility, health, and dependence. The quantified scores and values are aggregated and combined with a generated total monetary value of the network to provide a more effective indication of the total utility of the network to the organization.

Having thus described the basic concept of this technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for evaluating a network associated with an organization, the method comprising:
generating, with the network analyzer device, a relationship health score for each of a plurality of entities based on relationship utility scores and relationship strength scores generated for each pair of one of a plurality of connects and one of a plurality of connectors having a relationship, wherein the connectors are internal to the organization and the connects are each associated with one or more of the entities;
generating, with the network analyzer device, one or more connect dependence scores for each of the connects;
generating, with the network analyzer device, a total monetary value of the network based on a potential monetary value of the network and a realized monetary value of the network, the potential and realized monetary values respectively generated based on potential and executed interactions between the connectors and the connects;
generating, with the network analyzer device, a total value of the network based on the relationship health scores, the connect dependence scores, and the total monetary value of the network; and
outputting, with the network analyzer device, the total value of the network to an information consumer device.

2. The method of claim 1, further comprising:
obtaining, with the network analyzer device, an indication of all relationships for each of the connectors and each of the connects and the nature of the relationships, and an indication of a context for each of the relationships; and
wherein each of the relationship strength scores are further generated based on one or more of a nature of relationship score, a relationship bilaterality score, and or relationship context score.

3. The method of claim 1, further comprising:
obtaining, with the network analyzer device, an indication of seniority or position for each of the connectors and each of the connects and an indication of all relationships for each of the connectors and each of the connects; and
wherein each of the relationship utility scores is further generated based on a hierarchical score, a degree of influence score, and an influence propensity score.

4. The method of claim 1, further comprising:
obtaining, with the network analyzer device, an indication of all relationships for each of the connectors and each of the connects; and
wherein the connect dependence scores for each of the connects are generated based on whether the connect is associated with the entity and a total number of relationships between connectors and connects associated with the entity for each of the entities associated with one of the connects.

5. The method of claim 1, further comprising:
obtaining, with the network analyzer device, an indication of seniority or position for each of the connects; and
wherein the connect dependence scores for each of the connects are generated based on a seniority score of the connect as compared to a sum of a plurality of seniority scores of all of the connects associated with the entity for each of the entities associated with the connect.

6. The method of claim 1, wherein the connect dependence scores for each of the connects are generated based on a number of relationships between the connect and all of the entities as compared to the total number of relationships of all of the connects to all of the entities.

7. The method of claim 1, further comprising:
obtaining, with the network analyzer device, an indication of seniority or position for each of the connects; and
wherein the connect dependence scores for each of the connects are generated based on a seniority score of the connect as compared to a sum of seniority scores of all of the connects.

8. A network analyzer device, comprising:
a processor coupled to a memory and configured to execute programmed instructions stored in the memory, comprising:
generating a relationship health score for each of a plurality of entities based on relationship utility scores and relationship strength scores generated for each pair of one of a plurality of connects and one of a plurality of connectors having a relationship, wherein the connectors are internal to the organization and the connects are each associated with one or more of the entities;
generating one or more connect dependence scores for each of the connects;
generating a total monetary value of the network based on a potential monetary value of the network and a realized monetary value of the network, the potential and realized monetary values respectively generated based on potential and executed interactions between the connectors and the connects;
generating a total value of the network based on the relationship health scores, the connect dependence scores, and the total monetary value of the network; and
outputting the total value of the network to an information consumer device.

9. The device of claim 8, wherein the processor is further configured to execute programmed instructions stored in the memory further comprising:
obtaining an indication of seniority or position for each of the connectors and each of the connects and an indication of all relationships for each of the connectors and each of the connects; and
wherein each of the relationship utility scores is further generated based on one or more of a nature of relationship score, a relationship bilaterality score, and or relationship context score.

10. The device of claim 8, wherein the processor is further configured to execute programmed instructions stored in the memory further comprising:
obtaining an indication of seniority or position for each of the connectors and each of the connects and an indication of all relationships for each of the connectors and each of the connects; and
wherein each of the relationship utility scores is further generated based on a hierarchical score, a degree of influence score, and an influence propensity score.

11. The device of claim 8, wherein the processor is further configured to execute programmed instructions stored in the memory further comprising:
obtaining an indication of all relationships for each of the connectors and each of the connects; and
wherein the connect dependence scores for each of the connects are generated based on whether the connect is associated with the entity and a total number of relationships between connectors and connects associated with the entity for each of the entities associated with one of the connects.

12. The device of claim 8, wherein the processor is further configured to execute programmed instructions stored in the memory further comprising:
obtaining an indication of seniority or position for each of the connects; and
wherein the connect dependence scores for each of the connects are generated based on a seniority score of the connect as compared to a sum of a plurality of seniority scores of all of the connects associated with the entity for each of the entities associated with the connect.

13. The device of claim 8, wherein the connect dependence scores for each of the connects are generated based on a number of relationships between the connect and all of the entities as compared to the total number of relationships of all of the connects to all of the entities.

14. The device of claim 8, wherein the processor is further configured to execute programmed instructions stored in the memory further comprising:
obtaining an indication of seniority or position for each of the connects; and
wherein the connect dependence scores for each of the connects are generated based on a seniority score of the connect as compared to a sum of seniority scores of all of the connects.

15. A non-transitory computer readable medium having stored thereon instructions for evaluating a network associated with an organization comprising machine executable code which when executed by a processor, causes the processor to perform steps comprising:
generating a relationship health score for each of a plurality of entities based on relationship utility scores and relationship strength scores generated for each pair of one of a plurality of connects and one of a plurality of connectors having a relationship, wherein the connectors are internal to the organization and the connects are each associated with one or more of the entities;
generating one or more connect dependence scores for each of the connects;
generating a total monetary value of the network based on a potential monetary value of the network and a realized monetary value of the network, the potential and realized monetary values respectively generated based on potential and executed interactions between the connectors and the connects;
generating a total value of the network based on the relationship health scores, the connect dependence scores, and the total monetary value of the network; and
outputting the total value of the network to an information consumer device.

16. The medium of claim 15, further having instructions stored thereon comprising machine executable code which when executed by the processor further causes the processor to perform steps further comprising:
obtaining an indication of seniority or position for each of the connectors and each of the connects and an indication of all relationships for each of the connectors and each of the connects; and
wherein each of the relationship utility scores is further generated based on one or more of a nature of relationship score, a relationship bilaterality score, and or relationship context score.

17. The medium of claim 15, further having instructions stored thereon comprising machine executable code which when executed by the processor further causes the processor to perform steps further comprising:
obtaining an indication of seniority or position for each of the connectors and each of the connects and an indication of all relationships for each of the connectors and each of the connects; and
wherein each of the relationship utility scores is further generated based on a hierarchical score, a degree of influence score, and an influence propensity score.

18. The medium of claim 15, further having instructions stored thereon comprising machine executable code which when executed by the processor further causes the processor to perform steps further comprising:
obtaining an indication of all relationships for each of the connectors and each of the connects; and
wherein the connect dependence scores for each of the connects are generated based on whether the connect is associated with the entity and a total number of relationships between connectors and connects associated with the entity for each of the entities associated with one of the connects.

19. The medium of claim 15, further having instructions stored thereon comprising machine executable code which when executed by the processor further causes the processor to perform steps further comprising:
obtaining an indication of seniority or position for each of the connects; and
wherein the connect dependence scores for each of the connects are generated based on a seniority score of the connect as compared to a sum of a plurality of seniority scores of all of the connects associated with the entity for each of the entities associated with the connect.

20. The medium of claim 15, wherein the connect dependence scores for each of the connects are generated based on a number of relationships between the connect and all of the entities as compared to the total number of relationships of all of the connects to all of the entities.

21. The medium of claim 15, further having instructions stored thereon comprising machine executable code which when executed by the processor further causes the processor to perform steps further comprising:
obtaining an indication of seniority or position for each of the connects; and
wherein the connect dependence scores for each of the connects are generated based on a seniority score of the connect as compared to a sum of seniority scores of all of the connects.
